(19) United States
(12) Patent Application Publication
(10) Pub. No.: US 2023/0056595 A1
(43) Pub. Date: Feb. 23, 2023

(54) METHOD AND DEVICE FOR PREDICTING PROCESS ANOMALIES

(71) Applicant: SAMSUNG ELECTRONICS CO., LTD., Suwon-si (KR)

(72) Inventors: Sangkyu PARK, Seoul (KR); Junwoo SONG, Suwon-si (KR); Jaecheol LEE, Suwon-si (KR); Youngbum HUR, Suwon-si (KR); Sangdo PARK, Seoul (KR); Jinwon AN, Suwon-si (KR); Baejin LEE, Yongin-si (KR); Jun Haeng LEE, Hwaseong-si (KR)

(73) Assignee: SAMSUNG ELECTRONICS CO., LTD., Suwon-si (KR)

(21) Appl. No.: 17/690,310

(22) Filed: Mar. 9, 2022

(30) Foreign Application Priority Data
Aug. 19, 2021 (KR) 10-2021-0109436

(51) Int. Cl. G05B 23/02; G06N 3/04; G06N 3/08; G06K 9/62

(52) U.S. Cl. CPC G05B 23/024; G05B 23/0221; G05B 23/0281; G06N 3/04; G06N 3/08; G06K 9/6289; G06K 9/6277; G06K 9/6256

(57) ABSTRACT

A method and device for predicting an anomaly in a manufacturing process. The method includes receiving time-series equipment data including one or both of sensor data and specification data, converting the time-series equipment data into an image, dividing the image into a plurality of patch images, outputting a probability for each class associated with a sign of an anomaly in the time-series equipment data by inputting the plurality of patch images to a pretrained artificial neural network (ANN), and predicting the sign of the anomaly in the time-series equipment data by adjusting a probability weight for each class based on a preset standard.

### CROSS-REFERENCE TO RELATED APPLICATIONS

This application claims the benefit under 35 USC § 119(a) of Korean Patent Application No. 10-2021-0109436, filed on Aug. 19, 2021, in the Korean Intellectual Property Office, the entire disclosure of which is incorporated herein by reference for all purposes.

### BACKGROUND

### 1. Field

The following description relates to a method and device for predicting an anomaly in a product manufacturing process.

### 2. Description of Related Art

A monitoring engineer may perform an interlock and a visual analysis to determine whether a manufacturing process is operating normally in real time. When the engineer visually analyzes large-scale equipment (e.g., semiconductor equipment), he or she may need to analyze the pieces of equipment one at a time, and thus may not be able to readily manage all sensors. In addition, there may be differences between engineers, and even the same engineer may not be able to easily consistently determine whether an anomaly is present. Thus, the engineer may only monitor what he or she determines should be managed, resulting in a management blind spot.

When an interlock is applied to a manufacturing process and an anomaly is detected, setting a narrow operating range may lower equipment efficiency in case where the interlock occurs frequently, and setting a wide operating range may lower anomaly detection sensitivity. Issues may be avoided by accurately determining an operating range of a sensor, but determining an operating range of a sensor may not be easy when the sensor is in actual production equipment.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of predicting an anomaly in a manufacturing process includes receiving time-series equipment data including one or both of sensor data and specification data, converting the time-series equipment data into an image, dividing the image into a plurality of patch images, outputting a probability for each class associated with a sign of an anomaly in the time-series equipment data by inputting the plurality of patch images to a pretrained artificial neural network (ANN), and predicting the sign of the anomaly in the time-series equipment data by adjusting a probability weight for each class based on a preset standard.

The converting of the time series equipment data into the image may include separating and converting one or both of the sensor data and the specification data.

The separating and converting may include converting one or bot of the sensor data and the specification data into images each having a different color.

The outputting of the probability for each class may include inputting one or both of the sensor data and the specification data to different channels of the ANN.

The ANN may include a plurality of nodes differentiated to detect each class. The outputting of the probability for each class further may include outputting the probability for each class by calculating a weighted sum of an output for each of the plurality of nodes.

The dividing of the image into the plurality of patch images may include dividing the image based on a time flow. The outputting of the probability for each class may include outputting the probability for each class by inputting the divided patch images to the ANN based on the time flow.

The ANN may be trained to focus on a feature of recent data. The method may further include converting the plurality of patch images into a three-dimensional (3D) tensor. The outputting of the probability for each class may include outputting the probability for each class by inputting the 3D tensor to a 3D convolutional neural network (CNN)-based ANN.

The predicting of the sign of the anomaly may include predicting the sign of the anomaly in the time-series equipment data by comparing final output data in which the probability weight is adjusted for each class and a preset threshold value.

The ANN may be trained based on training time-series equipment data in which a class associated with the sign of the anomaly is labeled such that the sign of the anomaly is predicted.

The ANN may be trained based on data added by random shuffling of a preset region of the training time-series equipment data that has been labeled.

In another general aspect, a device for predicting an anomaly in a manufacturing process includes a processor. The processor is configured to receive time-series equipment data including one or both of sensor data and specification data, convert the time-series equipment data into an image, divide the image into a plurality of patch images, output a probability for each class associated with a sign of an anomaly in the time-series equipment data by inputting the plurality of patch images to a pretrained artificial neural network (ANN), and predict the sign of the anomaly in the time-series equipment data by adjusting a probability weight for each class based on a preset standard.

The processor may separate and convert one or both of the sensor data and the specification data.

The processor may convert one or both of the sensor data and the specification data into images each having a different color.

The processor may input one or both of the sensor data and the specification data to different channels of the ANN.

The ANN may include a plurality of nodes differentiated for detecting each class. The processor may output the probability for each class by calculating a weighted sum of an output for each of the plurality of nodes.

The processor may divide the image based on a time flow and output the probability for each class by inputting the divided patch images to the ANN based on the time flow. The ANN may be trained to focus on a feature of recent data.

The processor may predict the sign of the anomaly in the time series equipment data by comparing final output data in which the probability weight is adjusted for each class and a preset threshold value.

The processor may predict the sign of the anomaly in the time-series equipment data by comparing final output data in which the probability weight is adjusted for each class and a preset threshold value.

The ANN may be trained based on data added by random shuffling of a preset region of the training time-series equipment data that has been labeled.

Other features and aspects will be apparent from the following detailed description, the drawings, and the claims.

### BRIEF DESCRIPTION OF THE DRAWINGS

FIGS. 1A and 1B illustrate an example of a method of predicting an anomaly in a manufacturing process.

FIG. 2A illustrates an example of a focused-on region of time series equipment data.

FIG. 2B illustrates an example of time series equipment data.

FIG. 3A through 3C illustrate an example of dividing an image into a plurality of patch images and inputting the patch images to an artificial neural network (ANN).

FIG. 4 illustrates an example of a method of adjusting a probability weight for each class.

FIG. 5 illustrates an example of a method of dynamically adjusting a threshold value for each piece of equipment.

FIG. 6 illustrates an example of a method of predicting an anomaly in a manufacturing process using a plurality of nodes differentiated to detect each class.

FIG. 7 illustrates an example of a method of training an ANN through random shuffling.

FIG. 8 illustrates an example of a device for predicting an anomaly in a manufacturing process.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The following structural or functional descriptions of examples are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The following examples may be embodied in various types of products, for example, a personal computer (PC), a laptop computer, a tablet computer, a smart phone, a television (TV), a smart home appliance, an intelligent vehicle, a kiosk, and a wearable device. Hereinafter, examples will be described in detail with reference to the accompanying drawings. When describing the examples with reference to the accompanying drawings, like reference numerals refer to like components and a repeated description related thereto will be omitted.

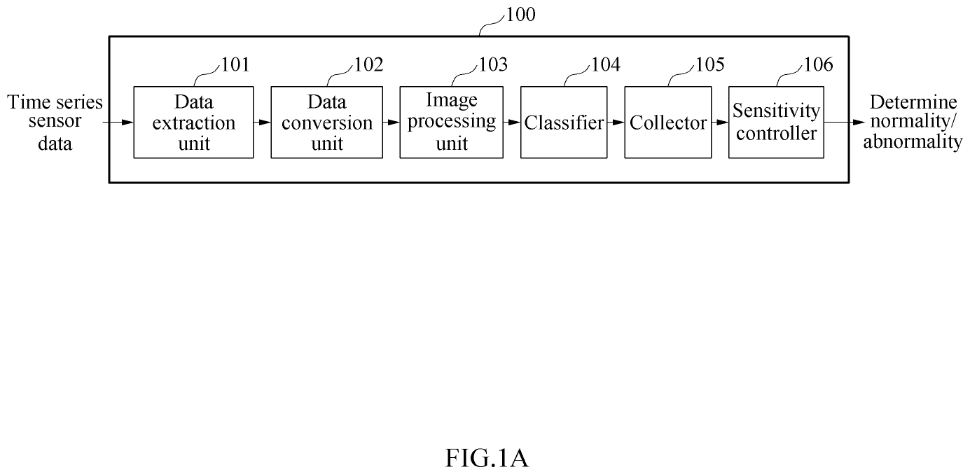

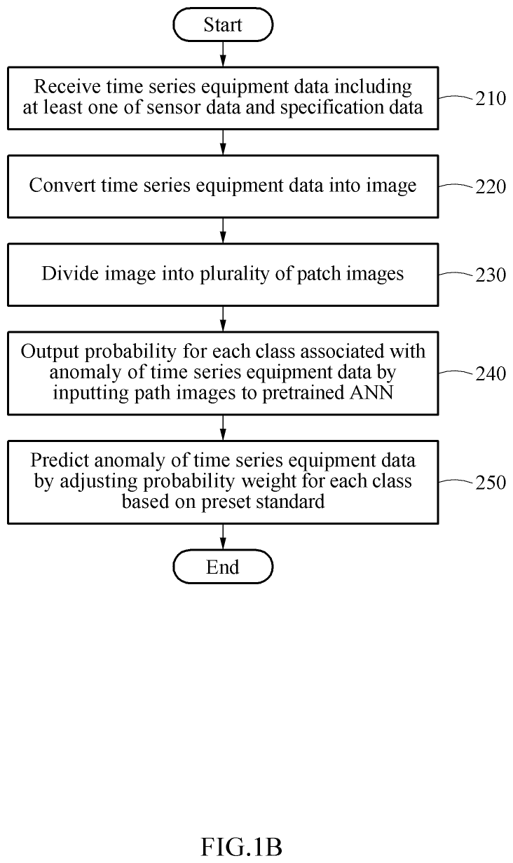

FIGS. 1A and 1B illustrate an example of a method of predicting an anomaly in a manufacturing process.

Referring to FIG. 1A, a device for predicting an anomaly in a manufacturing process, hereinafter simply referred to as a manufacturing process anomaly prediction device 100 may include at least one of a data extraction unit 101, a data conversion unit 102, an image processing unit 103, a classifier 104, a collector 105, and a sensitivity controller 106. In the example of FIG. 1A, components of the manufacturing process anomaly prediction device 100 are separately configured and are illustrated to describe functions to be distinguished. Thus, when an actual product is implemented, all the components may be configured to be processed by a processor or only some of the components may be configured to be processed by the processor.

The manufacturing process anomaly prediction device 100 may detect an anomaly in a manufacturing production process by monitoring a state of each piece of equipment included in the manufacturing production process. For example, in a case of a semiconductor manufacturing production process, the manufacturing process anomaly prediction device 100 may be provided with tens to hundreds of sensors and store sensor values at the same time interval while a wafer is being input and output, and thus may detect an anomaly in a stage of the manufacturing process by sensing slight movement changes of the sensor values that are different from a previous occurrence history. Conventionally, destructive testing may need to be performed to obtain a state of the product being produced. The manufacturing process anomaly prediction device 100 may obtain an integrity for each process stage in a non-destructive and indirect method.

For the convenience of description, although a method of predicting an anomaly that may occur in a semiconductor manufacturing production process is described as an example herein, the method of predicting an anomaly in a manufacturing process may be applied to various production processes utilizing equipment sensors, in addition to the semiconductor manufacturing production process.

Referring to FIG. 1B, operations 110 to 150 may be performed by the manufacturing process anomaly prediction device 100 described above with reference to FIG. 1A. The manufacturing process anomaly prediction device 100 may be implemented by one or more hardware modules, one or more software modules, or various combinations thereof.

In operation 110, the manufacturing process anomaly prediction device 100 may receive time-series equipment data, including at least one of sensor data and specification data. For example, the manufacturing process anomaly prediction device 100 may obtain time series equipment data through the data extraction unit 101.

The time series equipment data collected during a manufacturing production process may be stored in a data lake (e.g., fault detection classification (FDC) data lake). The data lake may be provided in the manufacturing process anomaly prediction device 100. In addition, the data lake may exist separately from the manufacturing process anomaly prediction device 100, and the manufacturing process anomaly prediction device 100 may receive the time series equipment data stored in the data lake.

The time series equipment data may include at least one sensor data and the specification data. The sensor data may be, for example, real-time data or a summary value of the real-time data from an equipment sensor used in a detailed process needed for production, including pressure in the etching chamber and an operating speed of a motor. The manufacturing process anomaly prediction device 100 may receive the sensor data from each of a plurality of sensors.

The specification data may be, for example, data indicating an upper limit and/or a lower limit of the corresponding sensor data. Data indicating the upper limit may be upper specification data, and data indicating the lower limit may be lower specification data. In addition, the specification data may be referred to as operating condition data.

In operation 120, the manufacturing process anomaly prediction device 100 may convert the time series equipment data into an image. The manufacturing process anomaly prediction device 100 may sense the time series equipment data for detecting a change in a distribution of the input time series equipment data. For example, the manufacturing process anomaly prediction device 100 may convert the time series equipment data into the image through the data conversion unit 102.

The time series equipment data may include the sensor data measured for a preset time and the specification data corresponding to the sensor data. Although the time series equipment data may be input to an artificial neural network (ANN) (e.g., a recurrent neural network (RNN) or a long short-term memory (LSTM)) to determine whether an anomaly is present in a manufacturing process, performance may be relatively low because anomaly data information is not used even when an actual anomaly data sample exists. Thus, the manufacturing process anomaly prediction device 100 may process the time series equipment data into the image and input the image to the ANN (e.g., a convolution neural network (CNN)) to determine whether the anomaly is present in the manufacturing process.

The manufacturing process anomaly prediction device 100 may convert the time series equipment data into the image in the form of a graph including a first axis and a second axis. Here, the first axis may indicate time, and the second axis in a vertical relationship with the first axis may indicate time series equipment data (e.g., sensor data or specification data) corresponding to a time.

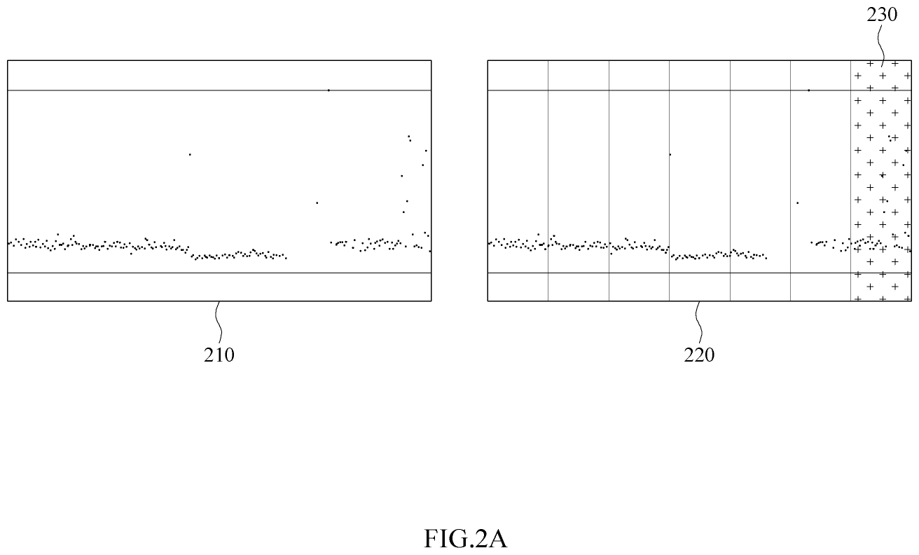

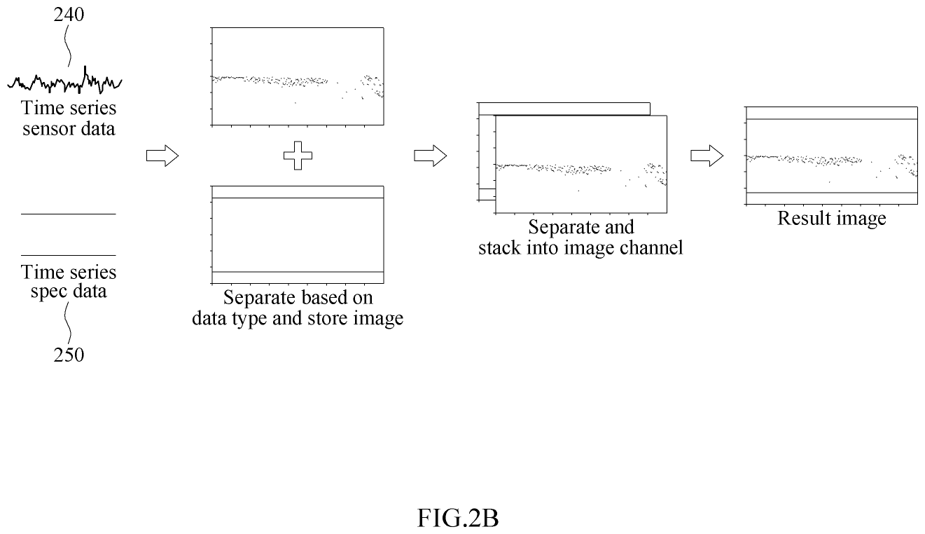

In operation 130, the manufacturing process anomaly prediction device 100 may divide the image into a plurality of patch images. The converted image may be processed again such that the converted image corresponds to an input of a training model. For example, the manufacturing process anomaly prediction device 100 may divide the image into a plurality of patch images through the image processing unit 103. The converted image may be divided such that a region in which an anomaly is to be determined is well-focused. Hereinafter, a focused-on region of the time series equipment data is described in detail with reference to FIG. 2A.

Referring to FIG. 2A, the manufacturing process anomaly prediction device 100 may convert time series equipment data into an image 210, and the image 210 may be divided into a plurality of patch images 220 such that a region 230 in which it is to be determined whether an anomaly is present may be well-focused.

Detecting an anomaly in a manufacturing production process may be performed to determine early whether the most recent data is abnormal compared to an existing pattern. When a manufacturing process engineer is visually monitoring to determine whether an anomaly is present in the manufacturing process, the focus may be on a region of recent data compared to previous data.

Thus, the manufacturing process anomaly prediction device 100 may divide the image 210 into a plurality of patch images 220 to focus on a feature of the recent data.

The manufacturing process anomaly prediction device 100 may divide the image into a plurality of patch images to represent the image in a temporal order. A patch image may refer to an image in which an image converted from the time series equipment data is divided into a plurality of sequential slices, similar to the time series equipment data.

Referring back to FIG. 1B, in operation 140, the manufacturing process anomaly prediction device 100 may input the patch images to the pretrained ANN and output a probability for each class associated with the anomaly in the time series equipment data. The probability may include a logit. The manufacturing process anomaly prediction device 100 may output the probability for each class associated with the anomaly in the time series equipment data through the classifier 104. For example, the classifier 104 may output the probability of the received time series equipment data being in a first class to an n class. A class associated with the anomaly may include, for example, an average value shift, a value drift, a multi value, and hunting.

The ANN may include an input layer, an output layer, and optionally, one or more hidden layers. Each layer may include one or more neurons, and the ANN may include neurons and synapses connecting neurons. Each neuron in the ANN may output a function value of an activation function for input signals, weights, and biases input through the synapses.

A model parameter may be determined through training and include a weight of a synaptic connection or a bias of a neuron. In addition, a hyperparameter may need to be set before a machine learning algorithm may be trained and include a learning rate, a number of repetitions, a mini-batch size, an initialization function, and the like.

The ANN may be trained to determine the model parameter minimizing a loss function. The loss function may be determined as an index to determine an optimal model parameter in a process of training the ANN.

The ANN may build an inference model by being trained for desired operations. In addition, the ANN may output an inference result associated with an external input value based on the built inference model.

The ANN may be trained based on the time series equipment data in which classes associated with the anomaly are labeled such that the anomaly may be predicted. Parameters of a neural network may be determined such that a difference between a class predicted through the ANN and a labeled class is minimized. Nodes of the layers in the ANN may be in a non-linear relationship affecting each other, and the parameters of the ANN such as values output respectively from the nodes and relationships between the nodes may be optimized by training.

An operation of training the ANN may be performed in a separate server device. The server device may use training data prepared in advance or training data collected from at least one user. In addition, the server device may use the training data generated by a simulation.

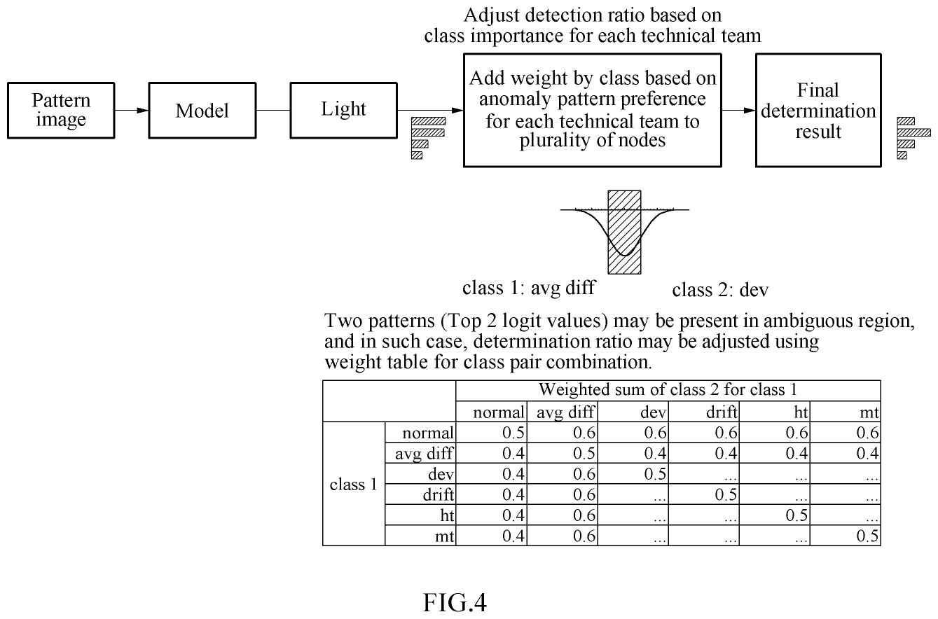

In operation 150, the manufacturing process anomaly prediction device 100 may predict the anomaly in the time series equipment data by adjusting probability weights for each class based on a preset standard. A form or shape of sensor data considered to be important for each process may vary, and thus the probability weight for each class may need to be adjusted. Hereinafter, a method of adjusting a probability weight for each class is described in detail with reference to FIG. 4.

FIG. 2B illustrates an example of time series equipment data.

Referring to FIG. 2B, time-series equipment data may include at least one of sensor data 240 and specification data 250. The manufacturing process anomaly prediction device 100 may separate and convert the sensor data 240 and the specification data 250.

In a case in which the sensor data 240 and the specification data 250 are not divided when a pattern shape of the time series equipment data is being learned, the sensor data 240 may overfit the specification data 250. Thus, the manufacturing process anomaly prediction device 100 may separate and convert the sensor data 240 and the specification data 250.

The manufacturing process anomaly prediction device 100 may convert the sensor data 240 and the specification data 250 into images of a different color. In addition, when time-series sensor data is input to the ANN, the manufacturing process anomaly prediction device 100 may input the sensor data 240 and the specification data 250 to different channels.

The manufacturing process anomaly prediction device 100 may analyze the specification data 250 and the sensor data 240 together or separately, as necessary. That is, the manufacturing process anomaly prediction device 100 may be trained with the specification data 250 along with the sensor data 240 to determine how close the sensor data 240 is to the specification data 250.

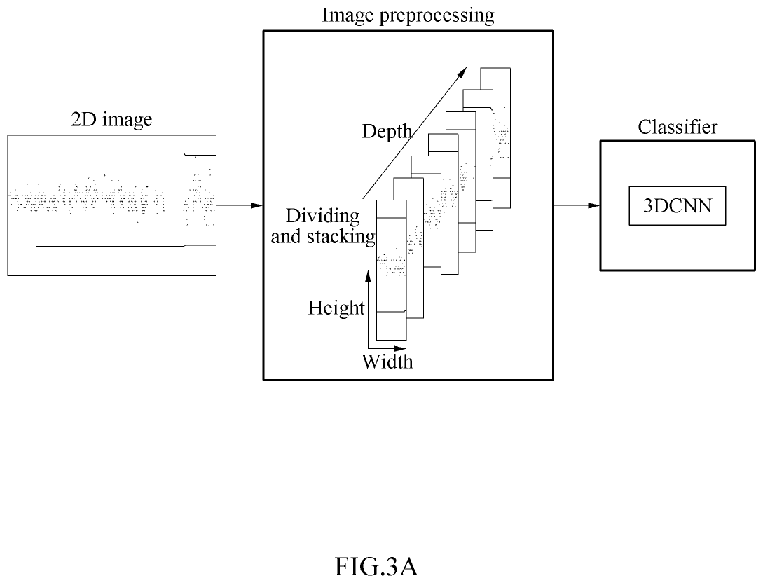

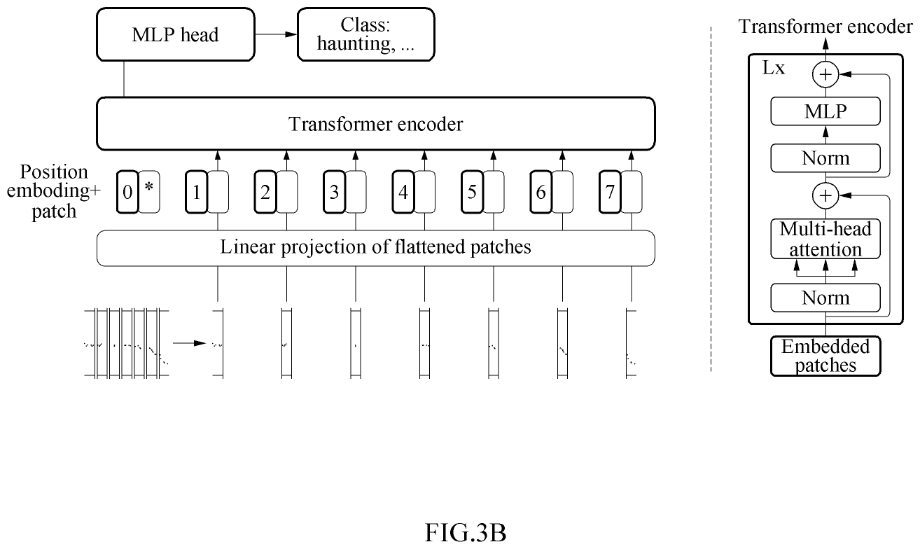

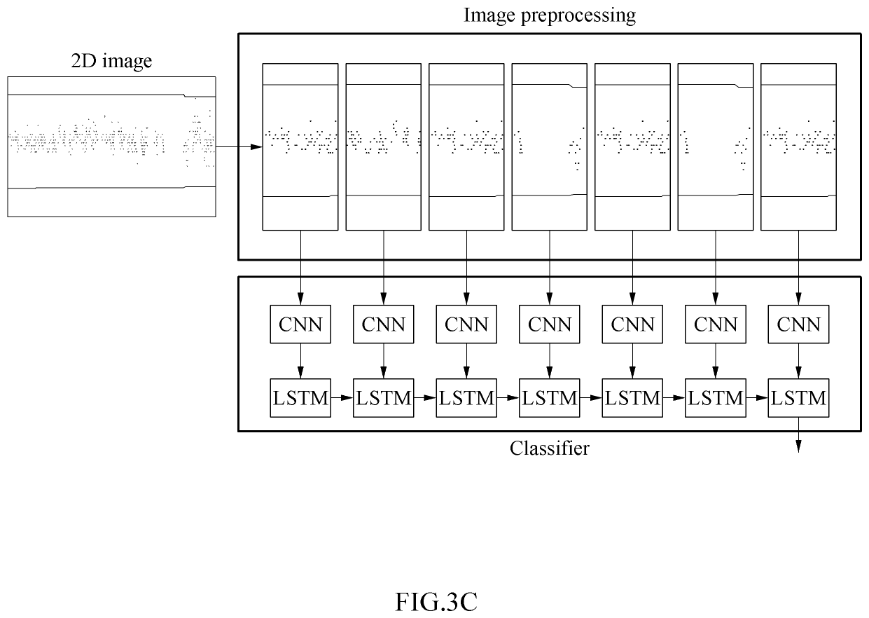

FIG. 3A through 3C illustrate an example of dividing an image into a plurality of patch images and inputting the patch images to an artificial neural network (ANN). The provided description with reference to FIGS. 1A through 2B also applies to FIGS. 3A through 3C. Thus, a more detailed description is not included here, for brevity.

Referring to FIG. 3A, the manufacturing process anomaly prediction device 100 may convert patch images into a three-dimensional (3D) tensor, input the 3D tensor to a 3D CNN-based ANN, and output a probability for each class.

When the 3D CNN-based classifier 104 is used, the image processing unit 103 may convert a two-dimensional (2D) image into a plurality of patch images as many as N having the same width and convert the 2D image into a 3D image form by stacking the patches in order.

The manufacturing process anomaly prediction device 100 may decide to artificially focus on a temporally close feature in response to recognizing a difference in a time series as a difference in a 3D depth form.

Referring to FIG. 3B, the manufacturing process anomaly prediction device 100 may divide a 2D image into N patch images and input the divided patch images to the classifier 104 for predicting an anomaly in a manufacturing process.

For example, the manufacturing process anomaly prediction device 100 may divide an image obtained by converting the time series equipment data of a week into a unit of a single day and input the divided image to the classifier 104. Each patch image may be divided into each class using a multilayer perceptron (MLP) head through an attention network in a divided state.

Referring to FIG. 3C, when the classifier 104 combined with 2D CNN and LSTM is used, the image processing unit 103 may divide a 2D image into N patch images in a temporal order. A classifier may output a result focused on a feature of recent data after being trained with a weight associated with an order.

FIG. 4 illustrates an example of a method of adjusting a probability weight for each class. The provided description with reference to FIGS. 1A through 3C also applies to FIG. 4. Thus, a more detailed description is not included here, for brevity.

A form or shape of sensor data considered to be important for each process may vary, and thus the probability weight for each class may need to be adjusted. Thus, the manufacturing process anomaly prediction device 100 may predict an anomaly in time series equipment data by adjusting probability weights for each class based on a preset standard.

Referring to FIG. 4, the manufacturing process anomaly prediction device 100 may predict the anomaly in the time series equipment data by adjusting the probability weights for each class based on a table to which weights for each pattern are applied.

For example, a pattern may not generally be easy to define as one class and have characteristics such that the pattern belongs to various classes. Even in such a case, the manufacturing process anomaly prediction device 100 may predict the anomaly in the time series equipment data by adjusting the probability weights for each class.

Referring to the table to which the weights for each pattern illustrated in FIG. 4 are applied, the probability weights for each class may be adjusted by multiplying 0.4 by a probability of an average difference class probability and 0.6 by a probability of a deviation class when probabilities of two classes (or top-2 class) including the average difference class and the deviation class predicted by the ANN are similar, and thus the manufacturing process anomaly prediction device 100 may finally determine the deviation class as a priority. For the convenience of description, the top-2 class is used for describing an example illustrated in FIG. 4, but examples may be expanded to include examples using a top-n class.

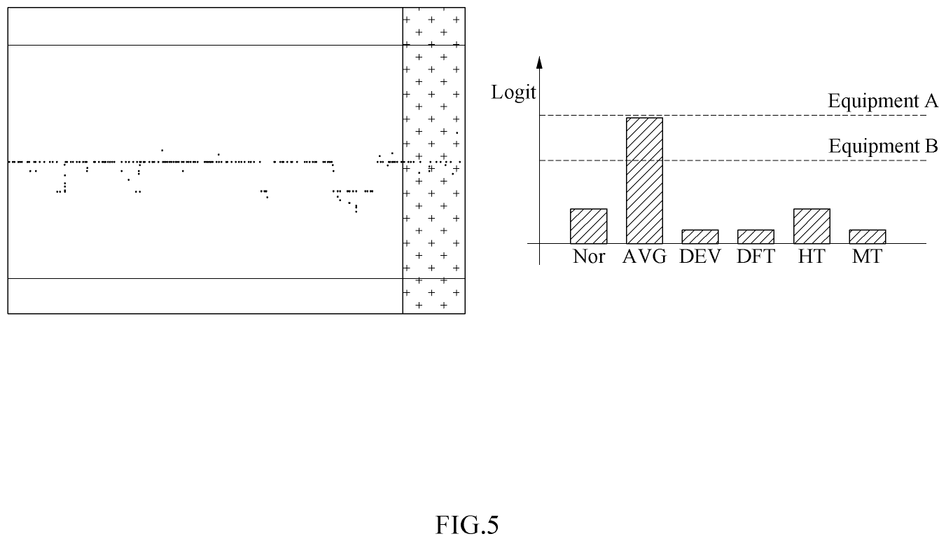

FIG. 5 illustrates an example of a method of dynamically adjusting a threshold value for each piece of equipment.

Referring to FIG. 5, the manufacturing process anomaly prediction device 100 may predict an anomaly in time series equipment data by comparing each final output data in which a weight is adjusted for each class and a preset threshold value. For example, the manufacturing process anomaly prediction device 100 may compare each of final output data in which the weight is adjusted and the preset threshold value, and when the final output data is greater than the threshold value, the manufacturing process anomaly prediction device 100 may predict that an anomaly corresponding to the class is present.

In a case of equipment A having low sensitivity, the manufacturing process anomaly prediction device 100 may ignore that a result of a classifier is abnormal and determine the result to be normal. However, in a case of equipment B having high sensitivity, the manufacturing process anomaly prediction device 100 may determine that an anomaly is present even when the same result is obtained.

The manufacturing process anomaly prediction device 100 may reflect the sensitivity by dynamically adjusting a threshold value for each piece of equipment. For example, the manufacturing process anomaly prediction device 100 may set the threshold value for determining the anomaly in equipment A to be less than a threshold value for determining the anomaly in equipment B. The manufacturing process anomaly prediction device 100 may arbitrarily change the threshold value when the equipment is being used.

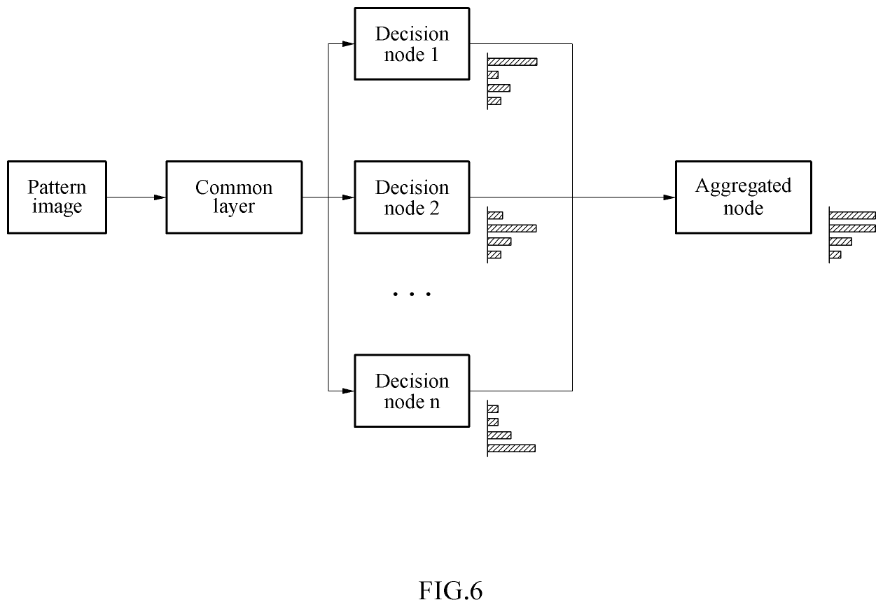

FIG. 6 illustrates an example of a method of predicting an anomaly in a process using a plurality of nodes differentiated to detect each class.

Referring to FIG. 6, an ANN may include a plurality of nodes differentiated to detect each class, and the manufacturing process anomaly prediction device 100 may output a probability for each class by calculating a weighted sum of each of the plurality of nodes.

The manufacturing process anomaly prediction device 100 may replace performing a plurality of classifier operations with calculating a weighted sum of an output for each of the plurality of nodes. For example, the ANN may assign a plurality of nodes differentiated to detect each class before a node from which a final logit is output. The manufacturing process anomaly prediction device 100 may output a final logit by calculating the weighted sum of the logits of such nodes. When the weighted sum is calculated, the same weight may be assigned to each of a plurality of nodes, but is not limited thereto, and the weight may be determined through various methods.

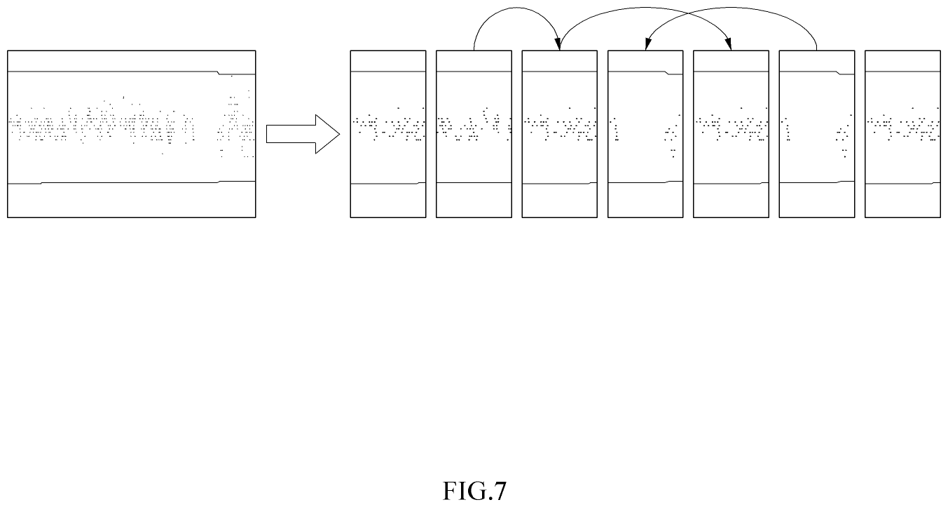

FIG. 7 illustrates an example of a method of training an ANN through random shuffling.

Referring to FIG. 7, an ANN may be trained based on data added by random shuffling of a preset region of labeled time series equipment data. The preset region may be a region in which the focused region described above is excluded.

As described above, the focus may be on a feature in recent data, and thus when region data that is not recent data is randomly shuffled, input of a classifier may be perturbed while a ground truth for normal/abnormal is maintained. When training data is insufficient, an amount of training data may be increased through random shuffling.

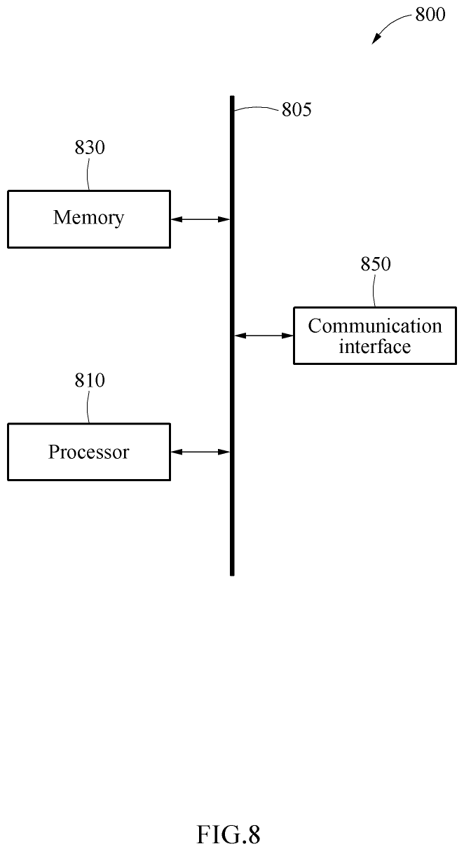

FIG. 8 illustrates an example of a device for predicting an anomaly in a process.

Referring to FIG. 8, a manufacturing process anomaly prediction device 800 may include a processor 810. The manufacturing process anomaly prediction device 800 may further include a memory 830 and a communication interface 850. The processor 810, the memory 830, and the communication interface 850 may communicate with each other through a communication bus 805.

The processor 810 may receive time-series equipment data including at least one of sensor data and specification data, convert the time series equipment data into an image, divide the image into a plurality of patch images, output a probability (logit) associated with an anomaly in the time series equipment data for each class by inputting pretrained patch images to an ANN, and predict the anomaly in the time series equipment data by adjusting a probability weight for each class based on a preset standard.

The memory 830 may store production process data. The memory 830 may be a volatile memory or a non-volatile memory.

The processor 810 may perform at least one method described above or an algorithm corresponding to the at least one method with reference to FIGS. 1A through 7. The processor 810 may execute a program and control the manufacturing process anomaly prediction device 800. A program code to be executed by the processor 810 may be stored in the memory 830. The manufacturing process anomaly prediction device 800 may be connected to an external device (e.g., a PC or a network) through an input/output device (I/O) (not shown) and exchange data. The manufacturing process anomaly prediction device 800 may be provided in various computing devices and/or systems such as a smart phone, a tablet computer, a laptop computer, a desktop computer, a TV, a wearable device, a security system, a smart home system, and the like.

The examples described herein may be implemented using hardware components, software components and/or combinations thereof. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described hardware devices may be configured to act as one or more software modules in order to perform the operations of the above-described examples, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of predicting an anomaly in a manufacturing process, comprising:
receiving time-series equipment data comprising one or both of sensor data and specification data;
converting the time-series equipment data into an image;
dividing the image into a plurality of patch images;
outputting a probability for each class associated with a sign of an anomaly in the time-series equipment data by inputting the plurality of patch images to a pretrained artificial neural network (ANN); and
predicting the sign of the anomaly in the time-series equipment data by adjusting a probability weight for each class based on a preset standard.

2. The method of claim 1, wherein the converting of the time series equipment data into the image comprises separating and converting one or both of the sensor data and the specification data.

3. The method of claim 2, wherein the separating and converting comprises converting one or both of the sensor data and the specification data into images each having a different color.

4. The method of claim 1, wherein the outputting of the probability for each class comprises inputting one or both of the sensor data and the specification data to different channels of the ANN.

5. The method of claim 1, wherein the ANN comprises a plurality of nodes differentiated to detect each class, and
wherein the outputting of the probability for each class comprises outputting the probability for each class by calculating a weighted sum of an output for each of the plurality of nodes.

6. The method of claim 1, wherein the dividing the image into the plurality of patch images comprises dividing the image based on a time flow,
wherein the outputting of the probability for each class comprises outputting the probability for each class by inputting the divided patch images to the ANN based on the time flow.

7. The method of claim 6, wherein the ANN is trained to focus on a feature of recent data.

8. The method of claim 1, further comprising:
converting the plurality of patch images into a three-dimensional (3D) tensor,
wherein the outputting of the probability for each class comprises outputting the probability for each class by inputting the 3D tensor to a 3D convolutional neural network (CNN)-based ANN.

9. The method of claim 1, wherein the predicting of the sign of the anomaly comprises predicting the sign of the anomaly in the time-series equipment data by comparing final output data in which the probability weight is adjusted for each class and a preset threshold value.

10. The method of claim 1, wherein the ANN is trained based on training time-series equipment data in which a class associated with the sign of the anomaly is labeled such that the sign of the anomaly is predicted.

11. The method of claim 10, wherein the ANN is trained based on data added by random shuffling of a preset region of the training time-series equipment data that has been labeled.

12. A non-transitory computer-readable storage medium storing instructions that, when executed by a processor, cause the processor to perform the method of claim 1.

13. A device for predicting an anomaly in a manufacturing process, comprising:
a processor configured to receive time-series equipment data comprising one or both of sensor data and specification data, convert the time-series equipment data into an image, divide the image into a plurality of patch images, output a probability for each class associated with a sign of an anomaly in the time-series equipment data by inputting the plurality of patch images to a pretrained artificial neural network (ANN), and predict the sign of the anomaly in the time-series equipment data by adjusting a probability weight for each class based on a preset standard.

14. The device of claim 13, wherein the processor is configured to separate and convert one or both of the sensor data and the specification data.

15. The device of claim 14, wherein the processor is configured to convert one or both of the sensor data and the specification data into images each having a different color.

16. The device of claim 13, wherein the processor is configured to input one or both of the sensor data and the specification data to different channels of the ANN.

17. The device of claim 13, wherein the ANN comprises a plurality of nodes differentiated for detecting each class,
wherein the processor is configured to output the probability for each class by calculating a weighted sum of an output for each of the plurality of nodes.

18. The device of claim 13, wherein the processor is configured to divide the image based on a time flow and output the probability for each class by inputting the divided patch images to the ANN based on the time flow,
wherein the ANN is trained to focus on a feature of recent data.

19. The device of claim 13, wherein the processor is configured to predict the sign of the anomaly in the time-series equipment data by comparing final output data in which the probability weight is adjusted for each class and a preset threshold value.

20. The device of claim 13, wherein the ANN is trained based on training time-series equipment data in which a class associated with the sign of the anomaly is labeled such that the sign of the anomaly is predicted.

21. The device of claim 20, wherein the ANN is trained based on data added by random shuffling of a preset region of the training time-series equipment data that has been labeled.
